(19) United States
(12) Patent Application Publication
(10) Pub. No.: US 2022/0022129 A1
(43) Pub. Date: Jan. 20, 2022

(54) EFFICIENT IDLE MODE CELL RESELECTION

(71) Applicant: Sony Group Corporation, Tokyo (JP)

(72) Inventors: Anders BERGGREN, Lund (SE); Torgny PALENIUS, Barseback (SE); Lars NORD, Lund (SE)

(21) Appl. No.: 17/295,304

(22) PCT Filed: Nov. 6, 2019
(86) PCT No.: PCT/EP2019/080410

§ 371 Date: May 19, 2021

(30) Foreign Application Priority Data
Nov. 23, 2018 (SE) 1830348-7

(51) Int. Cl. H04W 48/20; H04W 74/08; H04W 48/10

(52) U.S. Cl. CPC H04W 48/20; G16Y 10/75; H04W 48/10; H04W 74/0833

(57) ABSTRACT

A wireless communication device (10), an access node (30S) of a cellular network (50A, 50B) and methods (20; 40) of operating the same are provided. The methods (20; 40) comprise: communicating (201; 401), from the access node (30S) to the wireless communication device (10), information associated with at least one further access node (30F) of the cellular network (50A, 50B). The information comprises a type of a core network (40A, 40B) with which the at least one further access node (30F) is associated. Furthermore, the information enables the wireless communication device (10) to control (202) selection of the at least one further access node (30F).

### FIELD OF THE INVENTION

Various embodiments of the invention relate to a wireless communication device, an access node of a cellular network, and methods of operating the same.

### BACKGROUND OF THE INVENTION

In known cellular networks, wireless communication devices may enter an idle or disconnected mode when not actively participating in any communication, for saving battery capacity. In this mode, the device may still monitor radio signals of a serving cell of the cellular network for indicia of being paged, and for an RF performance of the serving cell. As necessary, for example due to device mobility, the wireless communication device may select a new serving cell from the neighboring cells, again based on the associated RF performance.

To this end, the device needs to acquire the broadcast frequencies of the neighboring cells as provided in the serving cell's SIB4 and SIB5, as well as the respective neighboring cell's PLMN identities and core network type as provided by each respective neighboring cell in SIB1.

The core network of the cellular network, which tracks the wireless communication device and maintains its device context, is informed only if the new serving cell belongs to a new tracking area.

Future cellular networks will likely comprise a combination of 4G and 5G technologies and thus involve different types of core networks. In particular, E-UTRA cells may be connected to either types of core networks. Despite this, cell (re-)selection in idle mode is still based on RF performance only. In such hybrid networks, a new serving cell may thus be associated with a core network that does not maintain the context of the respective device. In such an event, the device requires re-registration to the core network associated with the new serving cell.

To avoid the associated signaling load and battery consumption, the wireless communication device may enforce selection of serving cells associated with the core network type to which it is registered (see 3GPP TR 23.724, solution 42). In this approach, the device may disable an S1-mode when registered on a 5^{th} generation core network, and disable an N1-mode when registered on a 4^{th} generation core network. This will force the device to only select cells associated with the specific type of core network. However, the device still needs to acquire the information on the respective type of core network from the individual neighboring cells, and then only considers those neighboring cells supporting the specific type of core network. Again, this unnecessarily consumes battery resources.

The above approach has been specified in TS 24.501 clause 4.9.2 to force voice-centric smart phones to stay registered to a 4^{th} generation core network, for instance. However, in step c of this specification, it may even happen that the device shall make a search according to 3GPP TS 23.122 to a highest ranked PLMN (see 3GPP TR 24.501 clause 4.9.2, step c), following a lack of coverage by serving cells associated with the core network type to which the device has previously been registered. This entails a service gap and further unnecessary battery consumption.

### BRIEF SUMMARY OF THE INVENTION

In view of the above, there is a need in the art for devices and corresponding methods which address some of the above needs. There is in particular a need in the art for devices and corresponding methods which reduce signaling loads, associated battery consumption and time-to-service of terminal devices of cellular networks.

These underlying objects of the invention are each solved by the devices and corresponding methods as defined by the independent claims. Preferred embodiments of the invention are set forth in the dependent claims.

According to a first aspect, a method of operating a wireless communication device is provided. The method comprises: the wireless communication device receiving, from an access node of a cellular network, information associated with at least one further access node of the cellular network. The information comprises a type of a core network with which the at least one further access node is associated. The information enables the wireless communication device to control selection of the at least one further access node.

The receiving may be performed when the wireless communication device operates in a disconnected mode.

The receiving may comprise receiving the information included in broadcasted system information.

The method according to the first aspect may further comprise the wireless communication device controlling selection of the at least one further access node based on the type of the core network with which the at least one further access node is associated.

The controlling may further comprise selecting an access node of the at least one further access node.

The method according to the first aspect may further comprise the wireless communication device connecting to the selected access node using a random access procedure.

The controlling may be performed when the wireless communication device operates in a disconnected mode.

The controlling may further be based on a type of device associated with the wireless communication device.

The controlling may depend on whether the wireless communication device is an Internet of Things, IoT, device.

The controlling may further be based on a receive signal strength associated with the at least one further access node.

The at least one further access node may be configured to support an E-UTRA radio access technology.

The type of the core network with which the at least one further access node is associated may be selected from the group comprising: a 4G core network, a 5G core network having no capability of providing voice services, and a 5G core network having a capability of providing voice services.

According to a second aspect, a wireless communication device is provided. The device comprises: a processor arranged for receiving, from an access node of a cellular network, information associated with at least one further access node of the cellular network. The information comprises a type of a core network with which the at least one further access node is associated. The information enables the wireless communication device to control selection of the at least one further access node.

The wireless communication device may be arranged to perform the method of operating a wireless communication device of various embodiments.

According to a third aspect, a method of operating an access node of a cellular network is provided. The method comprises: the access node transmitting, to a wireless communication device, information associated with at least one further access node of the cellular network. The information comprises a type of a core network with which the at least one further access node is associated. The information enables the wireless communication device to control selection of the at least one further access node.

The transmitting may comprise transmitting the information included in broadcasted system information.

The at least one further access node may be configured to support an E-UTRA radio access technology.

The type of the core network with which the at least one further access node is associated may be selected from the group comprising: a 4G core network, a 5G core network having no capability of providing voice services, and a 5G core network having a capability of providing voice services.

According to a fourth aspect, an access node is provided. The access node comprises: a processor arranged for transmitting, to a wireless communication device, information associated with at least one further access node of the cellular network. The information comprises a type of a core network with which the at least one further access node is associated. The information enables the wireless communication device to control selection of the at least one further access node.

The access node may be arranged to perform the method of operating an access node of a cellular network of various embodiments.

According to a fifth aspect, a system is provided. The system comprises: a wireless communication device of various embodiments; and an access node of various embodiments.

### BRIEF DESCRIPTION OF THE DRAWINGS

Embodiments of the invention will be described with reference to the accompanying drawings, in which the same or similar reference numerals designate the same or similar elements.

FIG. 1 illustrates an exemplary cellular network, including a system of an embodiment.

FIGS. 2 and 3 respectively illustrate a wireless communication device of an embodiment and an access node of an embodiment.

FIG. 4 illustrates a method of operating a wireless communication device of an embodiment and a method of operating an access node of a cellular network of an embodiment.

### DETAILED DESCRIPTION OF EMBODIMENTS

Exemplary embodiments of the invention will now be described with reference to the drawings. While some embodiments will be described in the context of specific fields of application, the embodiments are not limited to this field of application. Further, the features of the various embodiments may be combined with each other unless specifically stated otherwise.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

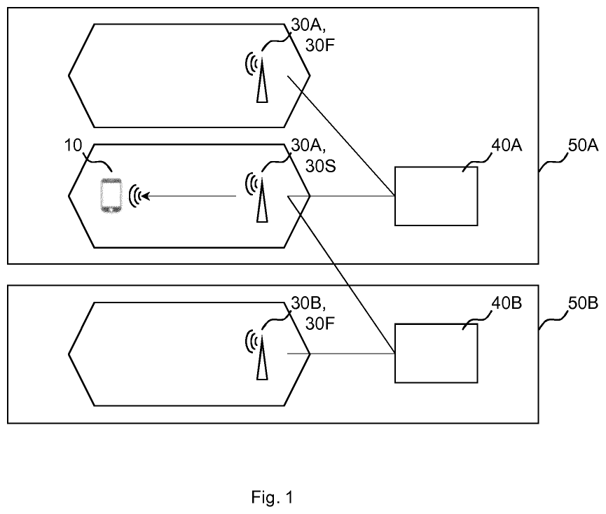

FIG. 1 illustrates an exemplary cellular network 50A, 50B including a system 10, 30S of an embodiment that comprises a wireless communication device 10 and a serving access node 30S.

As used herein, a cellular network may refer to a communication network comprising at least one core network and at least one radio access technology (RAT) to provide network connectivity to wireless communication devices. Network coverage is realized by organizing a RAT of the cellular network into geographic regions known as cells, wherein one or more cells are served by an access node. As a non-limiting example, a one-to-one correspondence of cells and serving access nodes is assumed for simplicity, as shown in FIG. 1.

As used herein, a radio access technology (RAT) may refer to a physical implementation of an air/radio interface of a wireless communication network, in particular a cellular network. Examples of RATs used in cellular networks include the Wide Area Network (WAN) radio technologies of 4^{th} generation (4G) Evolved UMTS Terrestrial Radio Access (E-UTRA) and 5^{th} generation (5G) New Radio (5GNR), as well as the Low Power Wide Area Network (LPWAN) radio technology of Narrowband IoT (NB-IoT).

As used herein, an access node may refer to a radio node of a wireless communication network, in particular of a cellular network, implementing an air/radio interface of the wireless communication network in an associated cell. Examples of access nodes used in cellular networks include 4^{th} generation Evolved NodeBs (eNB) 30A and 5^{th}/Next Generation NodeBs (gNB) 30B. An access node 30A, 30B may be selected as a serving access node 30S by wireless communication devices 10 being located in a cell/geographic coverage of that access node 30S in order to monitor radio signals of the serving access node 30S for indicia of being paged, for an RF performance of the serving access node 30S as well as for acquisition of broadcasted system information, for instance. According to the broadcasted system information, each serving access node 30S may have one or more further/neighboring access nodes 30F, from which the wireless communication device 10 may select a new serving access node 30S as necessary, for instance due to device mobility.

As used herein, a core network may refer to a plurality of functions implemented in a cellular network, in particular for service management, session management and mobility management. Examples of core networks include 4^{th} generation Evolved Packet Cores (EPC) 40A and 5th generation Cores (5GC) 40B.

With reference to FIG. 1, it will be appreciated that a cellular network 50A, 50B may comprise more than one generation of cellular network technology. As a non-limiting example, the cellular network 50A, 50B of FIG. 1 comprises 4G and 5G cellular networks 50A, 50B. As will be further appreciated, each generation of cellular network technology is associated with its own type of core network 40A, 40B and radio access technology (RAT) implemented by respective access nodes 30A, 30B.

As will be further appreciated, the 4G core network 40A is connected to each of the 4G access nodes 30A, and the 5G core network 40B is connected to each of the 5G access nodes 30B. However, as may be taken from the example of FIG. 1, the 5G core network 40B may additionally be connected to 4G access nodes 30A as well, which are enhanced to be connectable to a 5G core network.

As may further be taken from FIG. 1, wireless communication devices 10 may be located in cells associated with respective serving access nodes 30S. A wireless communication device 10 and a serving access node 30S together represent a system 10, 30S of an embodiment.

As used herein, a wireless communication device may refer to a device which may establish a network connectivity to a wireless communication network, in particular to a cellular network, via an air/radio interface of the wireless communication network, and maintain this connectivity in view of a mobility of the device. Examples of such devices comprise User Equipment (UE) devices and Internet of Things (IoT) devices.

As used herein, an IoT device may be a device with a low to moderate requirement on data traffic volumes and loose latency requirements. Additionally, communication employing IoT devices should achieve low complexity and low costs. Further, energy consumption of an IoT device should be comparably low in order to allow a battery power to function for a comparably long duration. For example, an IoT device may be connected to a core network via an NB-IoT RAT.

In known 3GPP cellular networks, serving access nodes 30S distribute lists of broadcast frequencies of their neighboring cells in their respective System Information Blocks (interFreqNeighCellList in SIB5, and intraFreqNeighbCellList in SIB4, see 3GPP TS 36.331). These neighboring cells may be associated with one or more Public Land Mobile Networks (PLMN), i.e., cellular networks 50A, 50B, and distribute a corresponding list of PLMN identities (PLMNIdentityList) in their respective System Information Block Type 1 (SIB1). As each cellular network 50A, 50B is associated with a type of core network 40A, 40B, for instance EPC or 5GC, a wireless communication device 10 has to acquire not only the SIB5 distributed by the serving access node 30S for the serving cell, but also the SIB1s distributed by the further/neighboring access nodes 30F for the neighboring cells, and rank the cells accordingly, to find out the type of core network for each further/neighboring cell 30F.

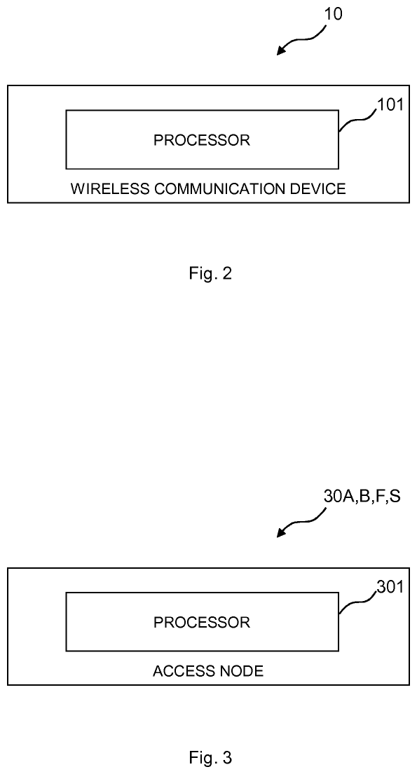

FIGS. 2 and 3 respectively illustrate a wireless communication device 10 of an embodiment and an access node 30F, 30S of an embodiment.

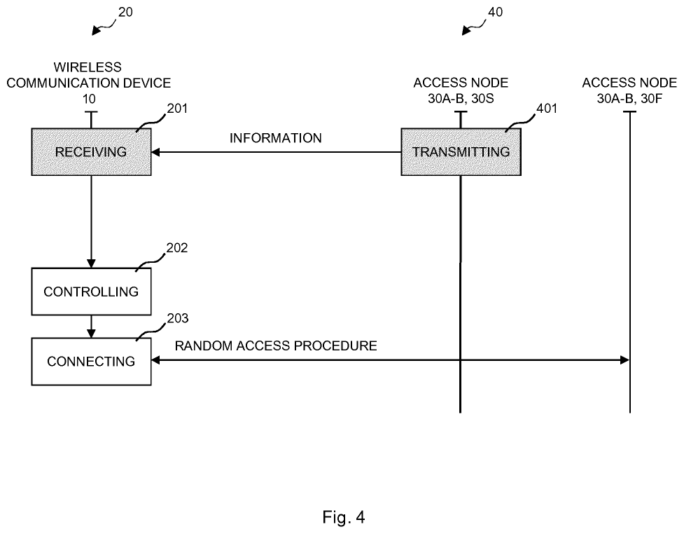

With reference to FIG. 2 and FIG. 4, it will be appreciated that a wireless communication device 10 comprises a processor 101. The processor 101 is arranged for receiving 201, from an access node 30S of the cellular network 50A, 50B, information associated with at least one further access node 30F of the cellular network 50A, 50B.

Correspondingly, with reference to FIG. 3 and FIG. 4, it will be appreciated that an access node 30S of a cellular network 50A, 50B comprises a processor 301. The processor 301 is arranged for transmitting 401, to the wireless communication device 10, information associated with at least one further access node 30F of the cellular network 50A, 50B.

With reference to both embodiments 10 and 30S, the information comprises a type of a core network 40A, 40B with which the at least one further access node 30F is associated, and enables the wireless communication device 10 to control 202 selection of the at least one further access node 30F.

In other terms, the above-mentioned information on the type of core network 40A, 40B may be included with the known lists of broadcast frequencies of the neighboring cells, such that the wireless communication device 10 does not have to acquire different pieces of information from a plurality of access nodes 30F to be able to determine a type of core network 40A, 40B to which the respective cell and access node 30F is associated.

This helps to reduce unnecessary signaling and battery consumption.

In addition, this facilitates a more efficient cell (re-)selection, since the wireless communication device 10 may focus on only those cells relevant to the type of core network 40A, 40B it is registered to, for continued connectivity to a specific type of core network 40A, 40B. Consequently, unnecessary signaling and battery consumption is avoided.

Furthermore, this simplifies PLMN reselection as referenced above following a lack of coverage by serving cells associated with the type of core network 40A, 40B to which the device 10 has previously been registered. By providing the wireless communication device 10 with the type of core network 40A, 40B associated with all neighboring cells in one go, the device 10 may quickly identify those cells not being associated with the type of core network 40A, 40B to which the device 10 has previously been registered.

FIG. 4 illustrates a method 20 of an embodiment of operating a wireless communication device 10 and a method 40 of an embodiment of operating an access node 30S of a cellular network 50A, 50B.

The method 20 of operating a wireless communication device 10 and the method 40 of operating an access node 30S of a cellular network 50A, 50B are respectively shown on left-hand and right-hand sides of FIG. 4.

With reference to the right-hand side of FIG. 4, it will be appreciated that method 40 comprises a step of the access node 30S transmitting 401, to the wireless communication device 10, information associated with at least one further access node 30F of the cellular network 50A, 50B.

With reference to the left-hand side of FIG. 4, it will be appreciated that method 20 comprises a corresponding step of the wireless communication device 10 receiving 201, from the access node 30S of the cellular network 50A, 50B, the information associated with the at least one further access node 30F of the cellular network 50A, 50B.

The information comprises a type of a core network 40A, 40B with which the at least one further access node 30F is associated, and enables the wireless communication device 10 to control 202 selection of the at least one further access node 30F.

In particular, the receiving 201 step may be performed when the wireless communication device 10 operates in a disconnected mode. In other words, idle mode mobility of the device 10 may be subject to battery savings.

In particular, the at least one further access node 30F may be configured to support an E-UTRA radio access technology. This relates to E-UTRA cells which may be connected to either EPC or 5GC or both.

In particular, the receiving 201 step may comprise receiving the information included in broadcasted system information. Correspondingly, the transmitting 401 may comprise transmitting 401 the information included in broadcasted system information. This broadcasted system information may, in particular, relate to the System Information Block Types 4 and 5 (SIB4, SIB5). Therefore, if the broadcasted system information related to E-UTRA frequencies is augmented with the type of core network 40A, 40B associated with the respective neighboring cell, the wireless communication device 10 may focus on only those cells relevant to the type of core network 40A, 40B it is, or is not, registered to, depending on the circumstances.

With continued reference to the left-hand side of FIG. 4, it will be appreciated that method 20 may further comprise a step of the wireless communication device 10 controlling 202 selection of the at least one further access node 30F based on the type of the core network 40A, 40B with which the at least one further access node 30F is associated. This may relate to one or more of the at least one further access node 30F which may be favored at the expense of the others of the at least one further access node 30F. In other terms, controlling 202 selection may result in a shortlist of the at least one further access node 30F.

In particular, the controlling 202 step may comprise selecting an access node 30A; 30B of the at least one further access node 30F. The selected access node 30A, 30B may be designated as a new serving access node 30S.

In particular, the controlling 202 step may be performed when the wireless communication device 10 operates in a disconnected mode. In other words, idle mode mobility of the device 10 may benefit from battery savings.

In particular, the controlling 202 step may further be based on a type of device associated with the wireless communication device 10. Alternatively or additionally, the controlling 202 step may depend on whether the wireless communication device 10 is an IoT device. Examples of IoT devices comprise NB-IoT devices or MTC (LTE Cat-0) devices.

For instance, Rel-14 devices (both smart phones and IoT devices) 10 would not need to monitor cells that are only connected to 5GC. In other words, they would not need to acquire the SIB1 of a neighboring cell that is only connected to 5GC.

For instance, a voice-centric (N1-disabled) Rel-15 smartphone 10 would not need to acquire the SIB1 for neighboring cells only connected to 5GC.

For instance, Rel-16 IoT devices 10 would not need to acquire the SIB1 for neighboring cells which are only connected to the type of core network 40A, 40B that the device 10 is not registered to (S1-disabled or N1-disabled) when performing normal idle mode cell reselection due to mobility. On top of the normal idle mode enhancement, the IoT device 10 may have a list of frequencies and/or cell identifiers to use to find the best suitable neighboring cell connected to the type of core network 40A, 40B that the device 10 is not registered to. This list is useful when the device 10 gets out of coverage of cells supporting the current type of core network 40A, 40B when the respective other type of core network 40A, 40B is disabled for the device 10. The device 10 will then be in a position to start a PLMN search based on said list for neighboring cells supporting the respective other type of core network 40A, 40B in the registered PLMN. This helps to reduce a service gap and a power consumption during the PLMN re-selection.

In particular, the controlling 202 step may further be based on a receive signal strength associated with the at least one further access node 30F. This integrates well with known idle mode cell (re-)selection based on RF performance.

With continued reference to the left-hand side of FIG. 4, it will be appreciated that method 20 may further comprise a step of the wireless communication device 10 connecting 203 to the selected access node 30A; 30B using a random access procedure.

This relates to the wireless communication device 10 switching to a connected mode, and attempting to use the new serving access node 30S for a data transfer, for instance.

In particular, the type of the core network 40A, 40B with which the at least one further access node 30F is associated may be selected from the group comprising: a 4G core network 40A, a 5G core network 40B having no capability of providing voice services, and a 5G core network 40B having a capability of providing voice services.

The technical effects and advantages described above in relation with the wireless communication device 10 and the method 20 of operating the wireless communication device 10 having corresponding features equally apply to the access node 30S and the method 40 of operating the access node 30S having corresponding features.

The present invention may, of course, be carried out in other ways than those specifically set forth herein without departing from essential characteristics of the invention. For example, the previous embodiments described the present invention in a hybrid 4G/5G context. However, those skilled in the art will appreciate that the present invention is not so limited. The present invention may also be used in other hybrid contexts involving 4G or 5G technologies. The present embodiments are therefore to be considered in all respects as illustrative and not restrictive, and all changes coming within the meaning and equivalency range of the appended claims are intended to be embraced therein.

1. A method of operating a wireless communication device, the method comprising:
the wireless communication device receiving, from an access node of a cellular network, information associated with at least one further access node of the cellular network,
wherein the information comprises a type of a core network with which the at least one further access node is associated, and
wherein the information enables the wireless communication device to control selection of the at least one further access node.

2. The method of claim 1,
wherein the receiving is performed when the wireless communication device operates in a disconnected mode.

3. The method of claim 1,
wherein the receiving comprises receiving the information included in broadcasted system information.

4. The method of claim 1, further comprising
the wireless communication device controlling selection of the at least one further access node based on the type of the core network with which the at least one further access node is associated.

5. The method of claim 4,
wherein the controlling comprises selecting an access node of the at least one further access node.

6. The method of claim 5, further comprising:
the wireless communication device connecting to the selected access node using a random access procedure.

7. The method of claim 4,
wherein the controlling is performed when the wireless communication device operates in a disconnected mode.

8. The method of claim 4, wherein the controlling is further based on a type of device associated with the wireless communication device.

9. The method of claim 8, wherein the controlling depends on whether the wireless communication device is an Internet of Things, IoT, device.

10. The method of claim 4, wherein the controlling is further based on a receive signal strength associated with the at least one further access node.

11. The method of claim 1,
wherein the at least one further access node is configured to support an E-UTRA radio access technology.

12. The method of claim 1, wherein the type of the core network with which the at least one further access node is associated is selected from the group comprising: a 4G core network, a 5G core network having no capability of providing voice services, and a 5G core network having a capability of providing voice services.

13. A wireless communication device, comprising:
a processor arranged for
receiving, from an access node of a cellular network, information associated with at least one further access node of the cellular network,
wherein the information comprises a type of a core network with which the at least one further access node is associated, and
wherein the information enables the wireless communication device to control selection of the at least one further access node.

14. (canceled)

15. A method of operating an access node of a cellular network, the method comprising:
the access node transmitting, to a wireless communication device, information associated with at least one further access node of the cellular network,
wherein the information comprises a type of a core network with which the at least one further access node is associated, and
wherein the information enables the wireless communication device to control selection of the at least one further access node.

16. The method of claim 15,
wherein the transmitting comprises transmitting the information included in broadcasted system information.

17. The method of claim 15,
wherein the at least one further access node is configured to support an E-UTRA radio access technology.

18. The method of claim 15, wherein the type of the core network with which the at least one further access node is associated is selected from the group comprising: a 4G core network, a 5G core network having no capability of providing voice services, and a 5G core network having a capability of providing voice services.

19-21. (canceled)
